(19) United States
(12) Patent Application Publication
(10) Pub. No.: US 2006/0069889 A1
(43) Pub. Date: Mar. 30, 2006

(54) Remote copy system

(76) Inventors: Masanori Nagaya, Tokyo (JP); Seiichi Higaki, Ninomiya (JP); Ryusuke Ito, Odawara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/008,300

(22) Filed: Dec. 10, 2004

(30) Foreign Application Priority Data
Sep. 29, 2004 (JP) 2004-284903

(51) Int. Cl. G06F 12/16

(52) U.S. Cl. 711/162; 711/114

(57) ABSTRACT

A reliable remote copy system is provided at low costs. The remote copy system includes a first storage system connected to a first upper level computing system to transmit or receive data to or from the first upper level computing system; a second storage system connected to the first storage system to receive data from the first storage system; and a third storage system connected to the second storage system to receive data from the second storage system and connected to a second upper level computing system to transmit or receive data to or from the second upper level computing system. Therefore, failover can be made from the first upper level computing system to the second upper level computing system. As a result, the upper level computing system connected to the second storage system is not required, and an inexpensive remote copy system can be realized.

### CROSS-REFERENCES TO RELATED APPLICATION

This application relates to and claims priority from Japanese Patent Application No. 2004-284903, filed on Sep. 29, 2004, the entire disclosure of which is incorporated herein by reference.

### BACKGROUND OF THE INVENTION

1. Field of the Invention

The present invention relates to a remote copy system for copying data between a plurality of storage systems.

2. Description of the Related Art

Recently, in order to allow a service to be continuously provided even when a storage system commonly used to provide a service to clients (referred to as a first storage system) is out of order, other storage systems (i.e., a second storage system located near the first storage system and a third storage system located far from the first storage system) are arranged in addition to the first storage system. Here, a technique of copying data stored in the first storage system to other storage systems is recently becoming important. As the technique of copying data stored in the first storage system to the second and third storage systems, for example, the following Patent Documents are disclosed. Patent document 1 discloses a technique in which the second storage system has two copy data corresponding to the copy target data of the first storage system, and the third storage system has one of the two copy data. Further, Patent Document 2 disclose a technique in which the second storage system has only one copy data corresponding to the copy target data of the first storage system, and the third storage system can obtain the copy data without a redundant logical volume to perform remote copying as described in Patent Document 1.

[Patent Document 1] U.S. Pat. No. 6,209,002

[Patent Document 2] Japanese Patent Laid-Open No. 2003-122509

In the prior arts, in order for the third storage system located far from the first storage system to obtain copy data, the second storage system is arranged between the first and third storage systems and data to be transmitted to the third storage system is temporarily stored in the second storage system. Therefore, the data loss is prevented, and a long distance remote copy can be achieved.

However, a user may often require a remote copy system that improves resiliency against failure using remote copy at a long distance, as well as lowering the system operating costs. For example, it is desirable that duplicated data stored in the first storage system be retained only in the third storage system.

With regard to the third storage system located at a long distance, in order to perform reliable copying of the data stored in the first storage system, the second storage system should be arranged in an intermediate site in consideration of the performance of the first storage system, and data is transmitted from the first storage system to the third storage system located at a long distance via the second storage system. In this case, it is desirable that the second storage system located in the intermediate site have a small logical volume.

However, in order to perform the remote copy of data from the second storage system to the third storage system, it is necessary that the second storage system have the same volume (copied volume) as the first storage system. This volume will also be large when the volume capacity of the first storage system is large. For example, when the technique disclosed in Patent Document 2 is applied, it is inevitable that the second storage system has the same volume as that for copying in the first storage system.

Further, since it is a large burden for a user to acquire all of three expensive storage systems, it is desirable that an inexpensive remote copy system be provided.

In addition, in a system performing failover from the first storage system to the third storage system, in the case in which the remote copying is performed in asynchronous transmission from the second storage system to the third storage system, it is necessary that, at the time of failover, a technique of matching the data image of the third storage system with data image of the first storage system should be established.

### SUMMARY OF THE INVENTION

The present invention is designed to solve the foregoing problems. Therefore, an object of the present invention is to provide an inexpensive and reliable remote copy system. In addition, another object of the present invention is to provide a remote copy system capable of performing failover to a third storage system when a first storage system is out of order. In addition, still another object of the present invention is to provide a remote copy system capable of suppressing the storage capacity of a second storage system to the minimum level while performing remote copying from a first storage system to a third storage system. In addition, yet still another object of the present invention is to provide a remote copy system capable of monitoring data communication traffic transmitted from a first storage system to a third storage system via a second storage system.

In order to solve the above-mentioned problems, according to a remote copy system of the present invention, there is provided a remote copy system comprising: a first storage system connected to a first upper level computing system to transmit or receive data to or from the first upper level computing system; a second storage system connected to the first storage system to receive data from the first storage system; and a third storage system connected to the second storage system to receive data from the second storage system and connected to a second upper level computing system to transmit or receive data to or from the second upper level computing system. In the remote copy system, the first storage system has a first storage area on which the data transmitted from the first upper level computing system is written, and the second storage system has a logical address on which the data transmitted from the first storage system is written and a second storage area on which data to be written on the logical address and update information on the data are written. In addition, the third storage system has a third storage area on which the data read from the second storage area and the update information on the data are written and a fourth storage area where the first storage area is copied, and after a predetermined time, the data written on the second storage area and the update information are read from the third storage system and are then written on the third storage area.

According to the present invention, since failover from the first upper level computing system connected to the first storage system to the second upper level computing system connected to the third storage system can be made, an inexpensive remote copy system can be implemented without a need to use the upper level computing system connected to the second storage system. For example, since the owner of the second storage system does not have to be the same owner of the first and third storage systems, a remote copy system can be implemented at low costs such as by borrowing the second storage system by the owner of the first and third storage systems.

### BRIEF DESCRIPTION OF THE DRAWINGS

FIG. 1 is a schematic diagram of a remote copy system according to a first embodiment of the present invention;

FIG. 2 is a schematic diagram of a first storage system;

FIG. 3 is a schematic diagram of a second storage system;

FIG. 4 is a schematic diagram of a third storage system;

FIG. 5 is a diagram for explaining a volume information table;

FIG. 6 is a diagram for explaining a pair establishment information table;

FIG. 7 is a diagram for explaining a journal group configuration information table;

FIG. 8 is a diagram for explaining journal data;

FIG. 9 is a flow chart for explaining an initial establishment processing;

FIG. 10 is a diagram for explaining an access command receiving process;

FIG. 11 is a flow chart for explaining the access command receiving process;

FIG. 12 is a diagram for explaining a journal command receiving process;

FIG. 13 is a flowchart for explaining the journal command receiving process;

FIG. 14 is a diagram for explaining a normalizing process;

FIG. 15 is a flow chart for explaining the normalizing process;

FIG. 16 is a flow chart for explaining a data image synchronizing process;

FIG. 17 is a schematic diagram of the second storage system;

FIG. 18 is a schematic diagram of a remote copy system according to a second embodiment of the present invention;

FIG. 19 is a diagram for explaining a pair configuration information table;

FIG. 20 is a flow chart for explaining an initial configuration process;

FIG. 21 is a diagram for explaining an access receiving process;

FIG. 22 is a flowchart for explaining the access receiving process;

FIG. 23 is a schematic diagram of a remote copy system according to a third embodiment of the present invention;

FIG. 24 is a schematic diagram of a second storage system;

FIG. 25 is a diagram for explaining a remote copy system available to a plurality of clients;

FIG. 26 is a schematic diagram of a remote copy system according to a fourth embodiment of the present invention; and

FIG. 27 is a schematic diagram of a remote copy system according to a fifth embodiment of the present invention.

### DESCRIPTION OF THE PREFERRED EMBODIMENT

Preferred embodiments of the present invention will now be described with reference to the accompanying drawings. Each embodiment is just for illustrative, and should not be construed to be restrictive. A number of modifications and changes can be made without departing from the scope of the present invention, which is defined by the appended claims and their equivalents.

### First Embodiment

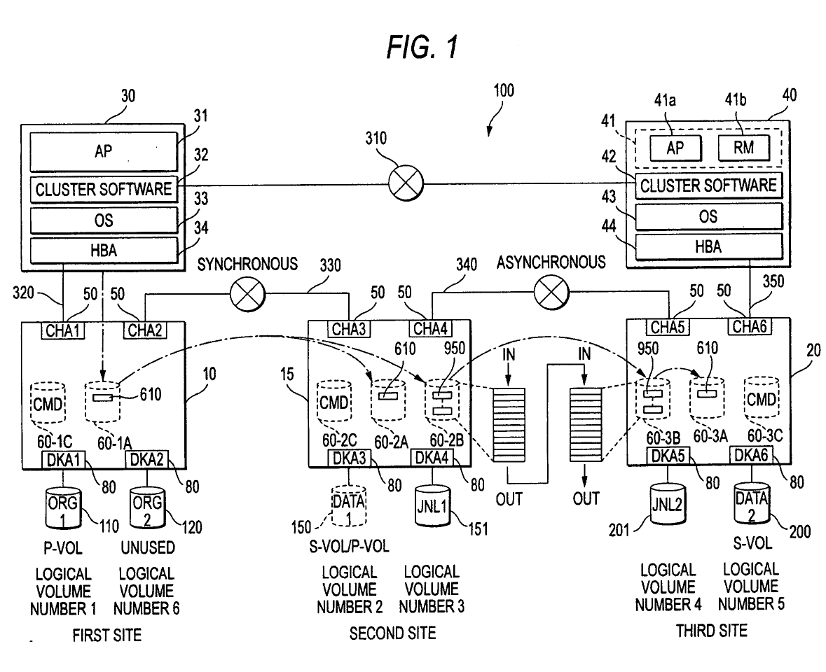

FIG. 1 is a schematic diagram of a remote copy system 100 according to the present invention. The remote copy system 100 includes a first storage system 10 arranged in a first site (primary site or main site), a second storage system 15 arranged in a second site (secondary site or local site), and a third storage system 20 arranged in a third site (remote site). The second site is located near to the first site while the third site is located far from the first site. The first storage system 10 is connected to a host computer (first upper level computing system) 30 to build an operating (active) data processing system. Further, the third storage system 20 is connected to a host computer (second upper level computing system) 40 to build an alternative (ready) data processing system. These data processing systems comprise clusters. When the operating data processing system is out of order, the data processing systems are configured to perform failover to the alternative data processing system.

The host computer 30 includes a host bus adapter 34 and is connected to a channel adapter (CHA1) 80 of the first storage system 10 by using a communication line 320. An operating system 33, cluster software 32, and an application program 31 are mounted in the host computer 30. The cluster software 32 checks whether the application program 31 is normally operated. Further, the host computer 40 includes a host bus adapter 44 and is connected to a channel adapter (CHA6) 80 of the third storage system 20 by using a communication line 350. An operating system 43, cluster software 42, and a resource group 41 are mounted in the host computer 40. The resource group 41 includes an application program 41a and a storage device management software (RAID manager) 42b. The host computers 30 and 40 are connected to each other through the communication line 310. In the case in which the first site is out of order and the application program 31 is not normally operated, the cluster software 42 detects trouble occurrence and sends an activation instruction to the host computer 40 of the alternative system. Accordingly, failover can be enabled from the operating data processing system to the alternative data processing system. In addition, as the application programs 31 and 41a, for example, an automatic telling machine and an airline reservation system can be used.

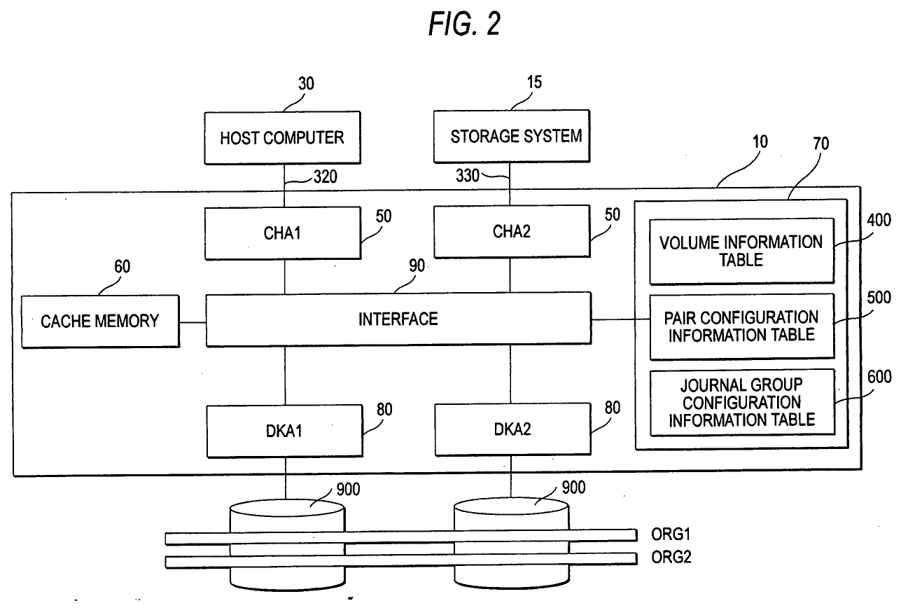

Next, the structure of the first storage system 10 will be described with reference to FIGS. 1 and 2. The first storage system 10 includes a channel adapter 50, a cache memory 60, a shared memory 70, a disk adapter 80, an interface 90, and a physical volume 900. The channel adapter 50 is an interface receiving an input or output request from the host computer 30. The cache memory 60 and the shared memory 70 are memories common to the channel adapter 50 and the disk adapter 80. The shared memory 70 is generally used to store control information and commands, etc. For example, a volume information table 400, a pair configuration information table 500, and a journal group configuration information table 600 are stored in the shared memory 70 (a detailed description will be described later) The cache memory 60 is generally used to temporarily store data.

For example, in the case in which a data input and output command received from the host computer 30 by the channel adapter 50 is a write command, the channel adapter 50 writes the write command in the shared memory 70 and write data received from the host computer 30 in the cache memory 60. Further, the disk adapter 80 monitors the shared memory 70. When the disk adapter 80 detects that the write command is written in the shared memory 70, it reads the write data from the cache memory 60 based on the write command and writes this in the physical volume 900.

Further, in the case in which the data input and output command received from the host computer 30 by the channel adapter 50 is a read command, the channel adapter 50 writes the read command in the shared memory 70 and checks whether data to be read exists in the cache memory 60. Here, in the case in which data to be read exists in the cache memory 60, the channel adapter 50 reads the data from the cache memory 60 to transmit it to the host computer 30. In the case in which data to be reading does not exist in the cache memory 60, the disk adapter 80 having detected that the read command has been written in the shared memory 70 reads the data to be read from the physical volume 900 to write this data in the cache memory 60, and writes this effect in the shared memory 70. In the case in which the channel adaptor 50 detects that the data to be read has been written in the cache memory 60 by monitoring the shared memory 70, the channel adaptor 50 reads the data from the cache memory 60 to transmit it to the host computer 30.

The disk adaptor 80 converts a data access request by the designation of the logical address transmitted from the channel adaptor 50 into a data access request by the designation of the physical address to write or read the data in/from the physical volume 900. In the case in which the physical volume 900 is configured of RAID, the disk adaptor 80 performs data access based on the RAID configuration. In other cases, the disk adaptor 80 performs replication control or remote copy control to achieve a copy management, backup management on data stored in the physical volume 900, and data loss prevention (disaster recovery) when a disaster breaks out.

The interface 90 interconnects the channel adaptor 50, the cache memory 60, the shared memory 70, and the disk adaptor 80. The interface 90 comprises a high-speed bus, such as an ultrahigh-speed crossbar switch for performing data transmission with, for example, high-speed switching. Accordingly, the communication performance between the channel adaptors 50 is significantly improved, and a high-speed file sharing function and high-speed failover can be performed. In addition, the cache memory 60 and the shared memory 70 can be constructed with different storage resources as described above. Alternatively, a portion of the storage area in the cache memory 60 can be allocated as the shared memory 70.

The first storage system 10 including one or a plurality of physical volumes 900 provides a storage area accessible from the host computer 30. In the storage area provided by the first storage system 10, a logical volume (ORG1) 110 and a logical volume (ORG2) 120 are defined in a storage space of one or a plurality of physical volumes 900. As the physical volume 900, a hard disk or a flexible disk can be used, for example. As the storage configuration of the physical volume 900, for example, a RAID type disk array by a plurality of disk drives may be used. In addition, the physical volume 900 and the storage system 10 may be connected to each other directly or through a network. Further, the physical volume 900 may be integrally constructed with the first storage system 10.

In the following description, original data, a target for copying, is stored in the physical volume (ORG1) 110. In addition, in order to easily distinguish the copy target data from the copy data, a logical volume having the copy target data therein is referred to as a primary logical volume (P-VOL), and a logical volume having the copy data therein is referred to as a secondary logical volume (S-VOL). In addition, a pair of primary logical volume and secondary logical volume is referred to as a pair.

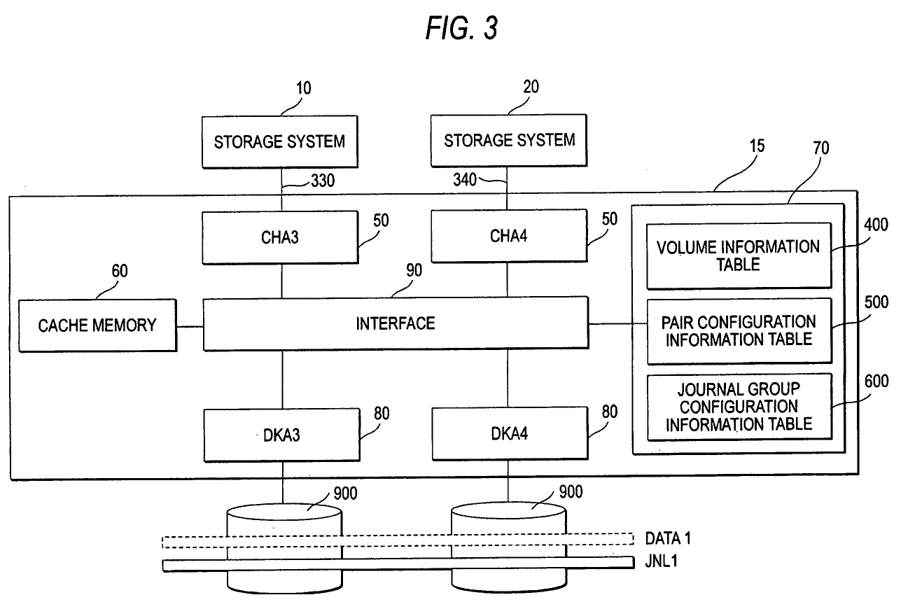

Next, the configuration of the second storage system 15 will be described with reference to FIGS. 1 and 3. In the drawings, the same components as those in FIG. 2 have the same reference numerals. Therefore, the detailed description thereof will be omitted. The second storage system 15 includes one or a plurality of physical volumes 900, and a logical volume (Data1) 150 and a logical volume (JNL1) 151 are defined in a storage space of one or a plurality of physical volumes 900. Here, the logical volume (Data1) 150 is a virtual volume, i.e., without a physical volume, virtually arranged to designate the storage area provided by the second storage system 15 based on the first storage system 10. The logical volume (Data1) 150 retains a copy of the logical volume (ORG1) 110. In addition, in the relationship between the logical volume (ORG1) 110 and the logical volume (Data1) 150, the former is designated as a primary logical volume, and the latter is designated as a secondary logical volume.

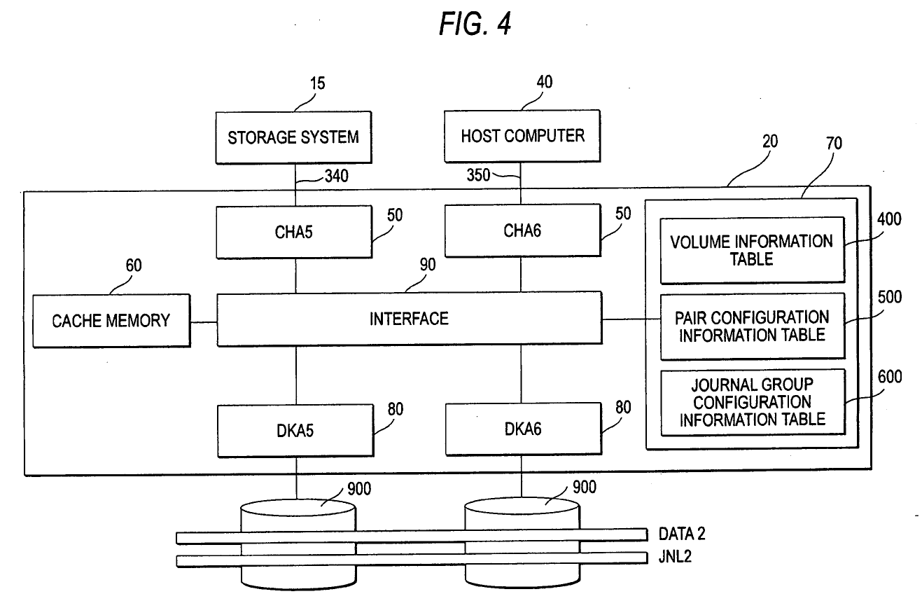

Next, the configuration of the third storage system 20 will be described with reference to FIGS. 1 and 4. In the drawings, the same components as those in FIG. 2 have the same reference numerals. Therefore, the detailed description thereof will be omitted. The third storage system 20 includes one or a plurality of physical volumes 900, and a physical volume (Data2) 200 and a physical volume (JNL2) 201 are defined in a storage space of one or a plurality of physical volumes 900. The logical volume (Data2) 200 retains a copy of the logical volume (Data1) 150. In addition, in the relationship between the logical volume (Data1) 150 and the logical volume (Data2) 200, the former is designated as a primary logical volume, and the latter is designated as a secondary logical volume.

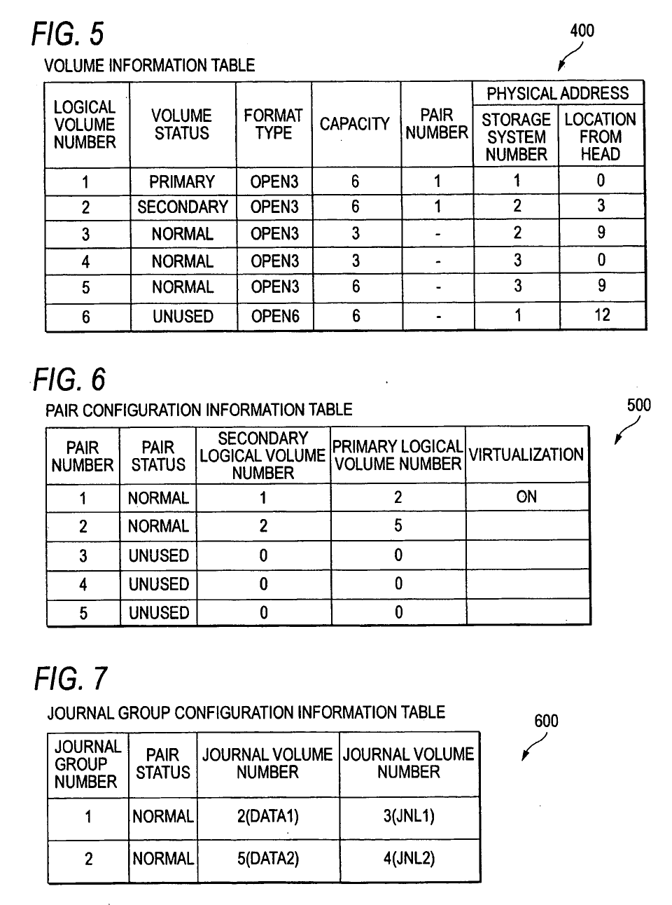

FIG. 5 shows a volume information table 400. In the volume information table 400, physical addresses on the physical volume 900 of each logical volume are defined. In addition, the capacity of each logical volume, property information, such as a format type, and pair information are defined. Here, for the convenience of description, although a logical volume number is considered as a unique one to the respective logical volumes in a remote copy system 100, the logical volume number may be uniquely defined in the unit of the respective storage systems. In addition, the logical volume number can be determined to be identifiable along with the identifier of the storage system itself. In the above table 400, logical volume number 1 refers to the logical volume (ORG1) 110, logical volume number 2 refers to the logical volume (Data1) 150, logical volume number 3 refers to the logical volume (JNL1) 151, logical volume number 4 refers to the logical volume (JNL2) 201, logical volume number 5 refers to the logical volume (Data2) 200, and logical volume number 6 refers to the logical volume (ORG2) 120, respectively. A pair having a pair number 1 is defined between the logical volume (ORG1) 110 and the logical volume (Data1) 150. In addition, the logical volume (ORG2) 120 is defined to be unused.

In addition, in the same table 400, a volume status ‘primary’ refers to a status where normal operation can be made with a primary logical volume, while ‘secondary’ refers to a status where normal operation can be made with a secondary logical volume. The term ‘normal’ refers to a status where a pair is not established with other logical volumes, but a normal operation can be performed. In addition, based on the physical address defined in the same table 400, the disk adaptor 80 controls writing data read from the cache memory 60 into the physical volume 900, or alternatively, writing data read from the physical volume 900 into the cache memory 60.

FIG. 6 shows a pair configuration information table 500. The table 500 defines the pair relation having a pair number 1 between the logical volume (ORG1) 110 and the logical volume (Data1) 150. In addition, the table 500 defines the pair relation having a pair number 2 between the logical volume (Data1) 150 and the logical volume (Data2) 200. Virtualization ‘ON’ in the table 500 represents that the secondary logical volume of the pair of logical volumes in the pair relation is virtualized. When the pair relation is set, write processing provided in the primary logical volume initiates other various processing on the secondary logical volume, corresponding to the pair status. For example, a pair state, a suspend state, and an initial copy state are provided as a pair status. In the case in which the pair status is in the pair state, a process in which the data having been written on the primary logical volume is also written on the secondary logical volume is attempted. In the case in which the pair status is in the suspend state, the data having been written to the primary logical volume is not reflected into the secondary logical volume, but a differential information bitmap is provided representing whether the data is updated to correspond to the primary logical volume at the time when the data on the primary and secondary logical volumes are in synchronous.

Next, journal data will be described. For the convenience of description, a source logical volume refers to an original logical volume in which data is updated, and a copy logical volume refers to a volume in which a copy of an update logical volume is contained. In the case in which there is a data update in some source logical volumes, the journal data comprises at least the updated data itself and update information representing where the update is made among the source logical volume (e.g., the logical address of the source logical volume). In the case in which there is data update in the source logical volume, when the journal data is retained, it is possible to reproduce the source logical volume from the journal data. In addition, assuming that the source logical volume and the copy logical volume are synchronized with each other at a certain timing so that both data images are equal to each other, in each case where the data update is made on the source logical volume, when the journal data is retained, the data image of the source logical volume after the certain timing can be reproduced to the copy logical volume by using the journal data. Here, by using the journal data, the data image of the source logical volume can be reproduced to the copy logical volume without a need of the same capacity with the source logical volume. The logical volume retaining the journal data is referred to as a journal logical volume. The above-mentioned logical volume (JNL1) 151 and the logical volume (JNL2) 201 are journal logical volumes.

FIG. 7 shows a journal group configuration information table 600. The journal group is preferably a logical volume-like pair. In the case in which data update is made on some logical volumes, the journal group is composed of journal volumes partitioned and stored into write data 610 and update information 620 such as on an address where a write command is written. In an example of the table 600, there are a journal group in which the logical volume (Data1) 150 and the logical volume (JNL1) 151 are defined as a journal group number 1, and another journal group in which the logical volume (Data2) 200 and the logical volume (JNL2) 201 are defined as a journal group number 2. In some cases, the journal group is called a journal pair.

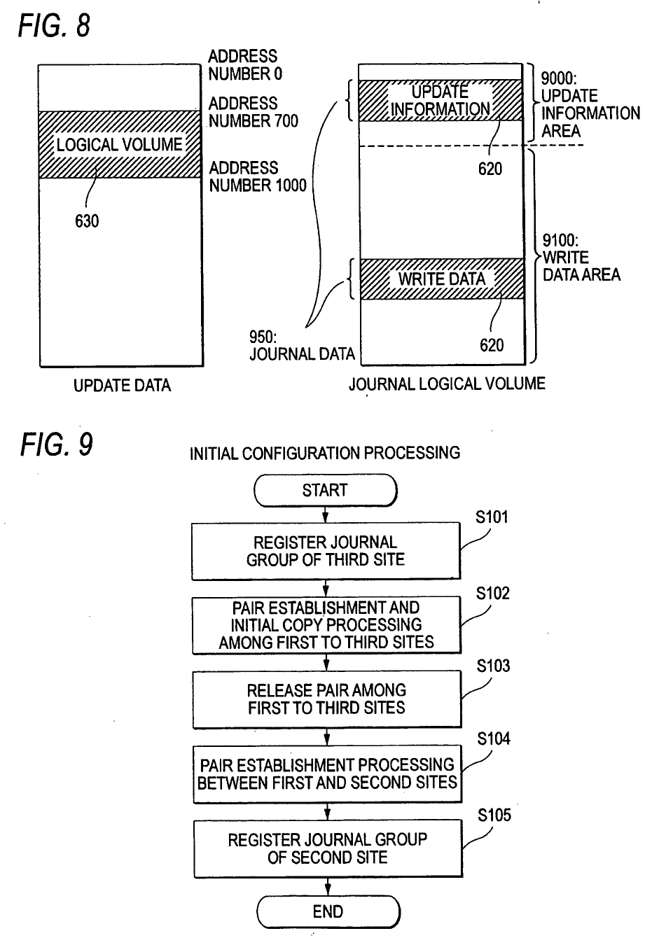

The journal data will now be described in more detail with reference to FIG. 8. In FIG. 8, address numbers 700 to 1000 of a certain source logical volume is updated by update data 630. The journal logical volume for the logical volume comprises an update information area 9000 and a write data area 9100. The update data 630 is written to the write data area 9100 as the write data 610. Here, the update data 630 and the write data 610 are equal to each other. In addition, information on the update such as which position of the source logical volume is updated (e.g., information representing that data in the addresses 700 to 1000 of the source logical volume are updated) is written to the update information area 9000 as the update information 620. The journal data 950 comprises the write data 610 and the update information 620. In the update information area 9000, when the update information 620 is stored from the top position in the order of update time, if the stored position of the update information 620 reaches the end of the update information area 9000, the update information 620 will be stored back from the top position of the update information area 9000. In the same manner, in the write data area 9100, when the write data 610 is stored from the top position in the order of the update time, if the stored position of the write data 610 reaches the end of the write data area 9100, the write data 610 will be stored back from the top position of the write data area 9100. The capacity ratio between the update information area 900 and the write data area 9100 may be a fixed value or an arbitrarily designated value.

Now, the operation of reflecting data update to the logical volume (ORG1) 110 of the first storage system 10 into the logical volume (Data2) 200 of the third storage system 20 through the second storage system 15 will be described with reference to FIG. 1. When the host computer 30 executes write access to the first storage system 10, the write command is issued with respect to a target channel adaptor (CHA1) 50. When receiving the write command, the target channel adaptor (CHA1) 50 writes the write data 610 into a storage area 60-1A of the cache memory 60. The write data 610 is read by the disk adaptor 80 and is written to the logical volume (ORG1) 110. Further, a channel adaptor (CHA2) 50 serves as an initiator and issues a write command for instructing the write data 610 written in the storage area 60-1A into the logical volume (Data1) 150 to a target channel adaptor (CHA3) 50 of the second storage system 15 through a communication line 330. When receiving the write command, the target channel adaptor (CHA3) 50 writes the write data 610 into a storage area 60-2A of the cache memory 60. In addition, the target channel adaptor (CHA3) 50 writes journal data 950 into a storage area 60-2B of the cache memory 60. The storage area 60-2B has a first in first out (FIFO) configuration, so that the journal data 950 is sequentially stored in a time series. The journal data is written to a logical volume (JNL1) 151 by a disk adaptor (DKA4) 80. In addition, according to the present embodiment, the logical volume (Data1) 150 is a virtual volume, so that write processing into the logical volume (Data1) 150 by a disk adaptor (DKA3) 80 is not performed.

The channel adaptor (CHA5) 50 of the third storage system 20 serves as an initiator and issues a journal read command requesting the transmission of the journal data to the target journal adaptor (CHA4) 50 of the second storage system 15 through a communication line 340 at a proper timing (PULL method). The target channel adaptor (CHA4) 50 having received the journal read command reads the journal data 950 stored in the storage area 60-2B in the order of old data and transmits the journal data 950 to the channel adaptor (CHA5) 50. The reading position of the journal data from the storage area 60-2B is designated by a pointer. When receiving the journal data, the channel adaptor (CHA5) 50 writes this into a storage area 60-3B of the cache memory 60. The storage area 60-3B has the FIFO configuration, so that the journal data 950 is sequentially stored in a time series. This journal data is written to a logical volume (JNL2) 201 by the disk adaptor (DKA5) 80. The disk adaptor (DKA5) 80 reads the journal data written into the logical volume (JNL2) 201 and writes the write data 610 into a storage area 60-3A of the cache memory 60. The write data 610 written into the storage area 60-3A is read by the disk adaptor (DKA5) 80 and is written to a logical volume (Data2) 200. Since the journal data 950 is retained in the logical volume (JNL2) 201, for example, normalization processing of the journal data 950 is not required for a case in which the second storage system 15 has a large load, but the normalization processing of the journal data 950 can be performed as the load of the second storage system 15 becomes smaller. In addition, after the journal data 950 is transmitted from the second storage system 15 to the third storage system 20, the journal data 950 may be automatically transmitted from the second storage system 15 to the third storage system 20 (PUSH method).

Further, as described above, a remote copy by synchronous transmission (synchronous copy) is performed between the first storage system 10 and the second storage system 15, while a remote copy by asynchronous transmission (asynchronous copy) is performed between the second storage system 15 and the third storage system 20. According to an example of the present embodiment, the synchronous copy herein refers to a processing that, when the host computer 30 requests the first storage system 10 to update data, the corresponding data is transmitted from the first storage system 10 to the second storage system 15, and that the data update completion of the first storage system 10 is guaranteed when the data update by the second storage system 15 is completed. By performing the synchronous copy between the first storage system 10 and the second storage system 15, data images of the logical volume (ORG1) 110 and the logical volume (Data1) 150 are always matched from a macroscopic point of view. ‘Always matched from a macroscopic point of view’ refers to a fact that data images are always matched at the time of completing the data update processing although not matched in a unit (μsec) of the processing time of the respective storage systems 10 and 15 and the data transmission time during the synchronous transmission of data. In contrast, according to an example of the present embodiment, the asynchronous copy refers to a sequence of processing that, for the extension of the data update request from the first storage system 10 to the second storage system 15, the corresponding data is not transmitted to the third storage system 20, and after completing data update to the second storage system 15, the data is asynchronously transmitted to the third storage system 20. In addition, the second storage system 15 transmits data to the third storage system 20 based on its own schedule (e.g., by selecting the time when the processing load is small) asynchronously with the data update request from the first storage system 10. The second storage system 15 performs an asynchronous copy with the third storage system 20. Here, the data images of the logical volume (Data2) 200 are matched with the data images of the logical volume (Data1) 150 at the previous timing, but not always matched with the data images of the logical volume (Data1) 150 at the present timing.

FIG. 9 is a flow chart for explaining an initial configuration procedure of the remote copy system 100. Here, the configuration may be set such that the user can makes desired control operations through a graphical user interface (GUI) of the service processor or the host computers 30 and 40. First, the user registers the journal group of the third storage system 20 (S101). More specifically, the journal group composed of the logical volume (Data2) 200 and the logical volume (JNL2) 201 are registered into the journal group configuration information table 600. Next, a pair relation is established between the logical volume (ORG1) 110 and the logical volume (Data2) 200 to perform an initial copy (S102). Accordingly, the same data images can be obtained in the logical volume (ORG1) 110 and the logical volume (Data2) 200. Therefore, after completing the initial copy, the pair relation between the logical volume (ORG1) 110 and the logical volume (Data2) 200 is released (S103). Next, a pair relation is established between the logical volume (ORG1) 110 and the logical volume (Data1) 150 (S104), and the logical volume (Data1) 150 and the logical volume (JNL1) 151 are registered as a journal group (S105). After this initial configuration processing, the normalization processing of the write data in the second storage system 15 can be performed.

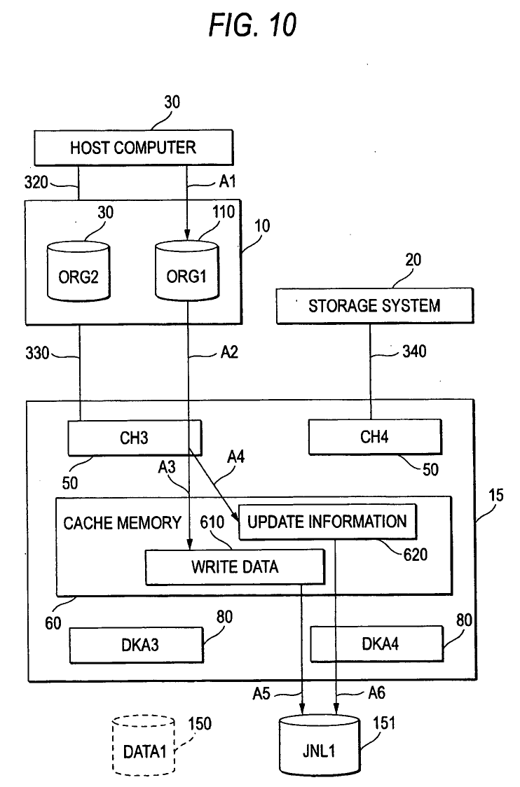

FIG. 10 is a diagram for explaining an access receiving process preformed by the second storage system 15. In FIG. 10, the same components as those in FIG. 1 have the same reference numerals, so that the detailed description thereof will be omitted. When receiving a write command from the host computer 30, the first storage system 10 writes data into a designated logical volume (ORG1) 110 (process A1). Here, the logical volume (ORG1) 110 of the first storage system 10 becomes a pair relation with the logical volume (Data1) 150 of the second storage system 15, so that the first storage system 10 issues to the second storage system 15 the same write command as one received from the host computer 30 (process A2). The write command is received by the target channel adaptor (CHA3) 50. The target channel adaptor (CHA) 50 determines whether the logical volume (Data1) 150, or the designated written place by the write command, is a physical volume or a virtual volume, based on the pair configuration information table 500. In the present embodiment, since the logical volume (Data1) 150 is set as the virtual volume, the target channel adaptor (CHA3) 50 regards the logical volume (Data1) 150 as a virtual one and writes the write data 610 into the storage area on the cache memory 60 corresponding to the write data area 9100 of the logical volume (JNL1) 151 (process A3). Further, the logical volume (Data1) 150 writes the result performed at the corresponding place such as the logical volume (Data1) 150 into the storage area of the cache memory 60 corresponding to the update information area 9000 of the logical volume (JNL1) 151, as update information 620 (process A4). The disk adaptor (DKA4) 80 writes the write data 610 and the update information 620 in the cache memory 60 to the logical volume (JNL1) 151 at the proper timing (processes A5 and A6).

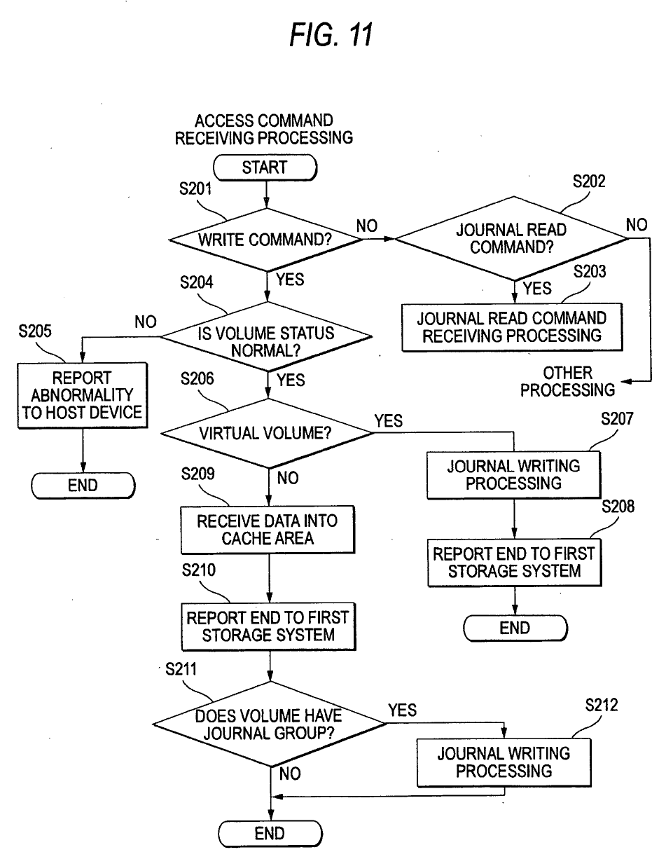

FIG. 11 is a flow chart for explaining an access receiving process performed by the second storage system 15. The access receiving process performed by the second storage system 15 will now be described with reference to FIG. 11. When the target channel adaptor (CHA3) 50 of the second storage system 15 receives an access command, it determines whether the access command is a write-command (S201). If the access command is not the write command (S201; NO), but is a journal command (S202; YES), a journal read command receiving process is preformed (S203). The journal read command receiving process will be described later in detail. On the other side, when the access command is the write command (S201; YES), it is determined that a write destination volume is in a normal state (S204). If the volume status is not normal (S204; NO), abnormality is reported to the service processor or the upper level device (the first storage device 10) (S205), and the processing is completed. Further, if the volume status is normal (S204; YES), it is determined whether the logical volume of the write destination is the virtual volume based on the pair configuration information table 500 (S206). If the logical volume of the write destination is the virtual volume (S206; YES), the write processing of the journal data 950 to the logical volume (JNL1) 151 is performed (S207), and the end report is informed to the upper level device (S208). On the other hand, if the logical volume of the write destination is not the virtual volume (S206; NO), data is written to the storage area of the cache memory 60 (S209), and the end report is informed to the upper level device (S210). Next, it is determined that the logical volume of the write destination is a logical volume having the journal group (S211). If the logical volume of the write destination has the journal group (S211; YES), the write processing of the journal data 950 to the logical volume (JNL1) 151 is performed (S212).

Accordingly, the logical volume (Data1) 150 is virtualized, so that the secondary logical volume does not have substantial storage capacity and can be defined as a relative position for the remote copy of the logical volume (ORG1) 110.

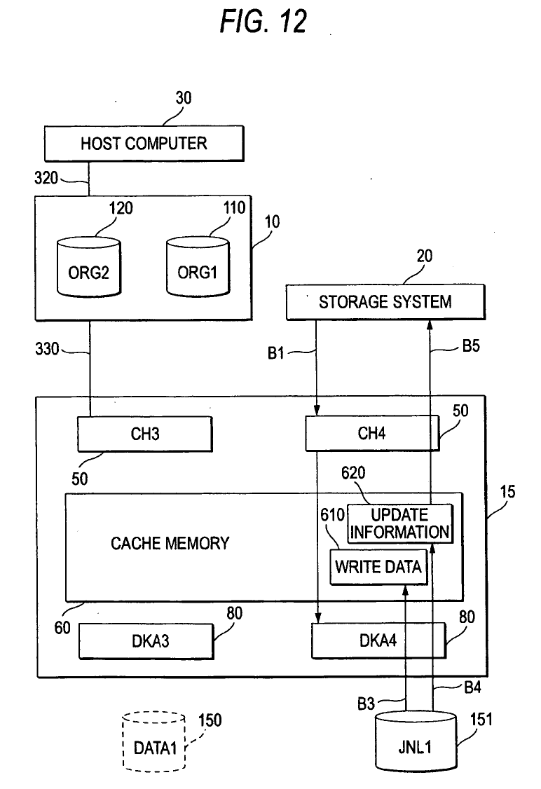

FIG. 12 is a diagram for explaining the operation of the target channel adaptor (CHA4) 50 of the second storage system 15 receiving the journal read command. The target channel adaptor (CHA4) 50 of the second storage system 15 receives a journal read command from the third storage system 20 (process B1). When untransmitted journal data 950 exists in the logical volume (JNL1) 151, the target channel adaptor (CHA4) 50 instructs the disk adaptor (DKA4) 80 to write the update information 620 and the write data 610 to the cache memory 60 (process B2). The disk adaptor (DKA4) 80 reads the update information 620 and the write data 610 from the logical volume (JNL1) 151 to write the update information 620 and the write data 610 into the cache memory 60, and informs the target channel adaptor (CHA4) 50 of the completion of read (processes B3 and B4). The target channel adaptor (CHA4) 50 receives the read completion report and reads the update information 620 and the write data 610 from the cache memory 60 to transmit them to the third storage system 20 (process B5). Accordingly, the cache memory 60 into which the journal data 950 is written is opened.

Although the embodiment of the present invention has been described with reference to the journal read command receiving process in which the journal data 950 read from the logical volume (JNL1) 151 is written to the cache memory 60, in the case in which the journal data 950 already exists in the cache memory 60, the reading of the journal data 950 from the logical volume (JNL1) 151 is not required. In addition, while the second storage system 15 transmits a single journal data 950 to the third storage system 20 separately, a plurality of journal data 950 may be transmitted to the third storage system 20 at the same time. In addition, the number of the journal data transmitted by the journal read command may be designated in the journal read command by the third storage system 20, or alternatively, may be registered in the second storage system 15 or the third storage system 20 by the user at the time when registering the journal group. In addition, the number of journal data transmitted from the second storage system 15 to the third storage system 20 may be dynamically changed in response to the transmission capability or the transmission load of the communication line 340. In addition, the process for opening the storage area of the journal data 950 by the second storage system 15 can be performed such that the third storage system may be opened in the journal read command, or the second storage system 15 may open the storage area of the journal data 950 according to designation.

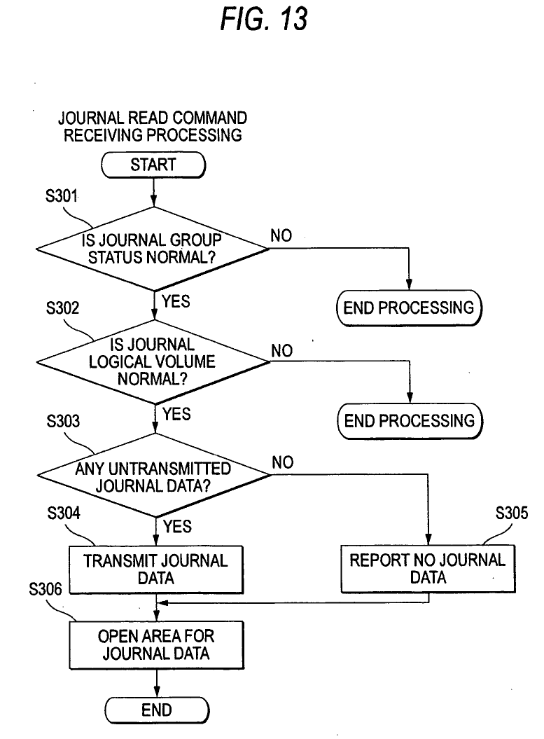

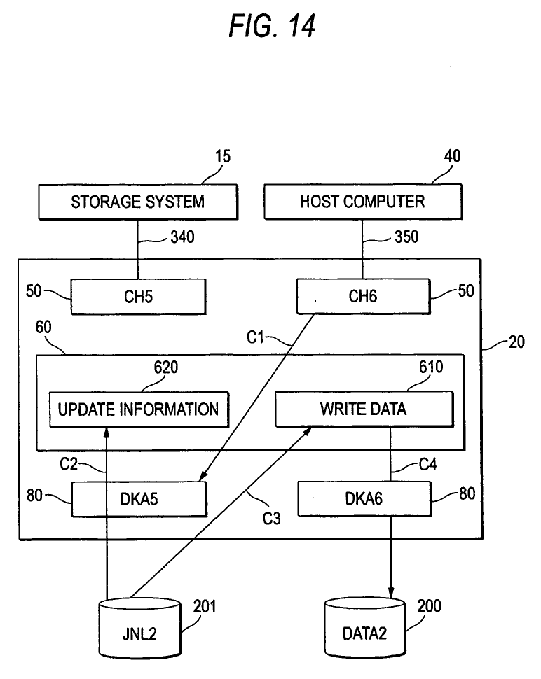

FIG. 13 is a flow chart for explaining the operation of the target channel adaptor (CHA4) 50 of the second storage system 15 that receives the journal read command. When the access command is received from the third storage system 20, in the case in which the access command is a journal read command, the target channel adaptor (CH4) 50 of the second storage system 15 determines whether a journal group status is normal with reference to the journal group configuration information table 600 (S301). When a trouble occurs in the journal group status, in the case in which the status is not normal (S301; NO), the journal group status is notified to the third storage system 20, and then the processing is ended. In the case in which the journal group status is normal (S301; YES), the target channel adaptor (CHA4) 50 determines whether the status of the logical volume (JNL1) 151 is normal (S302). In the case in which the status of the logical volume (JNL1) 151 is not normal (S302; NO), the target channel adaptor (CHA4) 50 changes the pair status of the journal group configuration information table 600 as “out of order”, reports the effect to the third storage system 20, and then ends the processing. On the other hand, in the case in which the status of the logical volume (JNL1) 151 is normal (S302; YES), the target channel adaptor (CHA4) 50 determines whether the untransmitted journal data 950 exists in the logical volume (JNL1) 151 (S303).

When the untransmitted journal data 950 exists in the logical volume (JNL1) 151 (S303; YES), the target channel adaptor (CHA4) 50 transmits the journal data 950 to the third storage system 20 (S304). The third storage system 20 having received the journal data 950 performs a normalization process to reflect the data update for the logical volume (ORG1) 110 to the logical volume (Data2) 200. On the other side, in the case in which the untransmitted journal data 950 does not exist in the logical volume (JNL1) 151 (S303; NO), the target channel adaptor (CHA4) 50 reports the effect to the third storage system 20 (S305) Next, the storage area of the logical volume (JNL1) 151 to which the journal data 950 is written is opened (S306). That is, after duplicating data in the first storage system 10 and the third storage system 20, the second storage system 15 can open the data. Accordingly, the storage resource of the second storage system 15 can be used in other ways.

FIG. 14 is a diagram for explaining an operation in which the channel adaptor (CHA6) 50 of the third storage system 20 performs data update in the logical volume (Data2) 200 by using the journal data 950. When the journal data 950 to be normalized exists in the logical volume (JNL2) 201, the normalization process is performed on the oldest journal data 950. The update number is continuously given to the journal data 950. It is desirable that the normalization processing be performed from the journal data 950 having the smallest (oldest) update number. The channel adaptor (CHA6) 50 reserves the cache memory 60 and instructs the disk adaptor (DKA5) 80 to read the update information 620 and the write data 610 starting from those with the oldest update information (process C1). The disk adaptor (DKA5) 80 writes the update information 620 and the write data 610 read from the logical volume (JNL2) 201 in the cache memory 60 (processes C2 and C3). Then, the disk adaptor (DKA5) 80 reads the write data 610 from the cache memory 60 and writes the write data 610 into the logical volume (Data2) 200 (process C4). Next, the storage area where the write data 610 and the update information 620 reflecting the data update of the logical volume (Data2) 200 exist is opened. In addition, the disk adaptor (DKA5) 80 may perform the normalization processing.

In addition, in the case in which the amount of the untransmitted journal data exceeds a predetermined threshold, it is desirable that the access from the host computer 30 to the first storage system 10 be restricted (e.g., the response of the first storage system 10 is delayed), and the transmission of the journal data 950 from the second storage system 15 to the third storage system 20 is performed first.

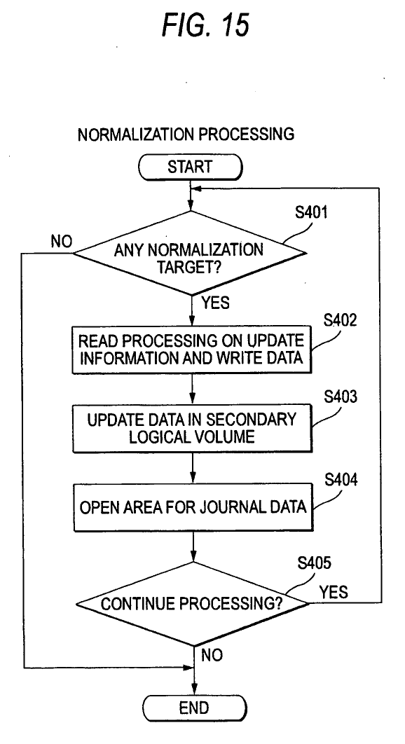

FIG. 15 is a flow chart for explaining an operation sequence of the normalization processing by the channel adaptor (CHA6) 50 of the third storage system 20. The channel adaptor (CHA6) 50 determines whether the journal data 950 to be normalized exists in the logical volume (JNL2) 201 (S401). In the case in which the journal data 950 to be normalized does not exist (S401; NO), the normalization processing is momentarily ended and is resumed after a predetermined period of time (S401). In the case in which the journal data 950 to be normalized exists (S401; YES), an instruction is transmitted to the disk adaptor (DKA5) 80 to read the update information 620 and the write data 610 from logical volume (JNL2) 201 to the cache memory 60 (S402). Next, the disk adaptor (DKA5) 80 writes into the logical volume (Data2) 200 the write data 610 read from the cache memory 60 to perform the data update of the logical volume (Data2) 200 (S403). Next, the storage area where the write data 610 and the update information 620 reflecting the data update of the logical volume (Data2) 200 exist is opened (S404). The channel adaptor (CHA6) 50 determines whether to continuously perform the normalization process (S405), and if the process is continued (S405; YES), the process returns to S401.

In addition, when the operating data processing system is out of order, the process fails over to the alternative data processing system. However, since the remote copy between the second storage system 15 and the third storage system 20 is performed through the asynchronous transmission, at the time when the operating data processing system is out of order, the data images of the logical volume (ORG1) 110 of the first storage system 10 and the data images of the logical volume (Data2) 200 of the third storage system 20 may be different from each other in many cases. Likewise, when the data images in two storage systems are different from each other, the processing having performed until now by the host computer 30 using the first storage system 10 cannot be linked to the host computer 40 using the third storage system 20. Now, a process of synchronizing the data image of the logical volume (Data2) 200 of the third storage system 20 with the data image of the logical volume (ORG1) 110 of the first storage system 10, at the time of failover, will be described.

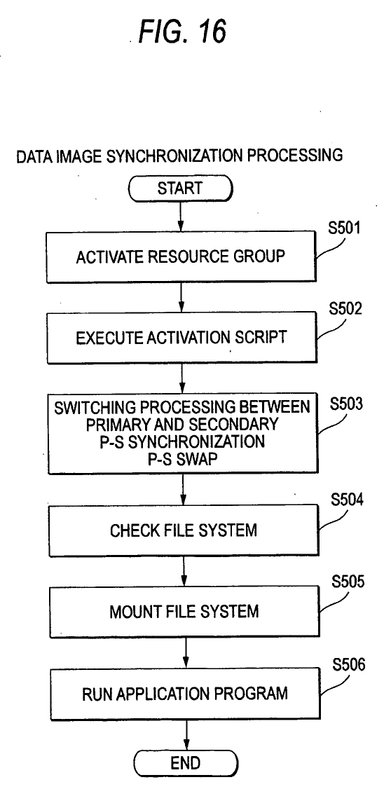

FIG. 16 is a flow chart for explaining a procedure for synchronizing the data images of the third storage system 20 with those of the first storage system 10 at the time of failover. For example, when the first storage system 10 is out of order, the first storage system 10 cannot respond to the input and output request from the application program 31. The application program 31 retries the request, and finally, fails to be down. Then, the cluster software 32 detects the trouble occurrence and transmits the activation instruction to the alternative system. When cluster software 42 of the alternative system receives the activation instruction from the cluster software 32 of the operating system, the cluster software 42 drives the resource group 41 (S501). Accordingly, an activation script is executed (S502). When the activation script is executed, first, a P-S swap processing (horctakeover command) is performed (S503). In the P-S swap processing, the pair status between the logical volume (Data1) 150 as a primary logical volume and the logical volume (Data2) 200 as a secondary logical volume becomes momentarily a suspend state. Under this state, the untransmitted journal data 950 is transmitted from the second storage system 15 to the third storage system 20, and the data update of the logical volume (Data2) 200 is performed. How much the untransmitted journal data 950 remains in the second storage system 15 can be appreciated by performing a reference from the third storage system 20 to the second storage system 15. More specifically, in storage device management software 41b, when a command (command for referring to the second storage system 15 to obtain the remaining amount of the journal data 950) is written to a command device 60-3C of the third storage system 20, the channel adaptor (CHA5) 50 refers to the second storage system 15. Likewise, when the data images of the logical volume (Data1) 150 and the data images of the logical volume (Data2) 200 are synchronized (P-S synchronization), a process in which the logical volume (Data2) 200 is changed into the primary logical volume and the logical volume (Data1) 150 is changed into the secondary logical volume is performed (P-S swap process). In general, the write access to the secondary logical volume is prohibited. Therefore, the logical volume (Data2) 200 is changed into the primary logical volume so that the write access from the host computer 40 to the logical volume (Data2) 200 is enabled. Accordingly, when the P-S swap process is completed, the storage device management software 41b checks whether a file system is corrupted (S504), and confirms that the file system is normally operated to mount the file system (S505). Then, the storage device management software 41b activates the application program 41a (S506). Therefore, the host computer 40 may use the third storage system 20 to reflect the processing performed by the host computer 30 at the time of failover.

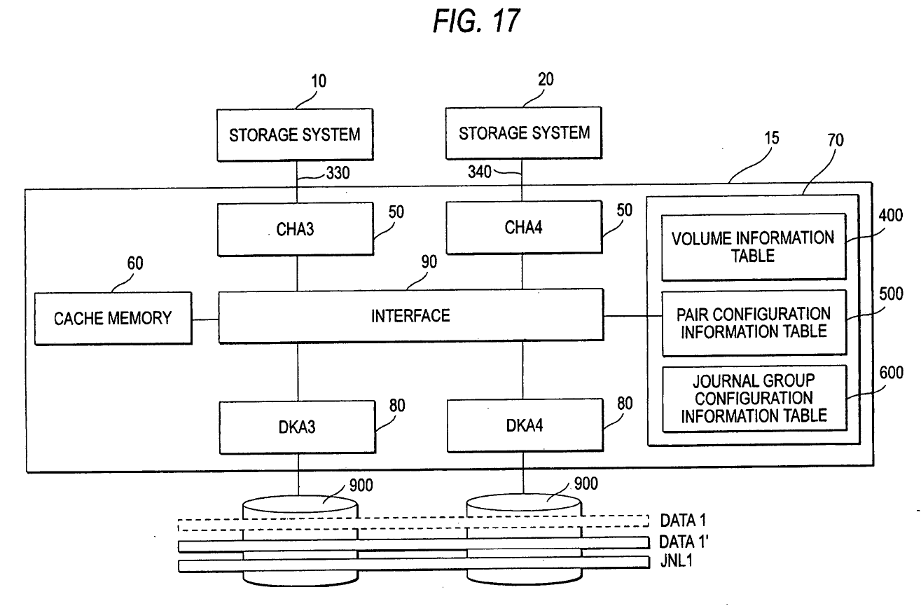

Next, data duplication will be described with reference to a case in which the third storage system 20 is out of order. According to the present embodiment, the logical volume (Data1) 150 of the second storage system 15 is a virtual volume rather than a physical volume. In the case in which the third storage system 20 is out of order, since the physical data remains only in the first storage system 10, it is desirable that reliability be enhanced by duplicating data. When the third storage system 20 is out of order, the second storage system 15 automatically or manually assigns the logical volume (Data1′) on the physical volume 900, as shown in FIG. 17. The logical volume (Data1′) is a physical volume having addresses for designating the storage area, provided from the first storage system 10, by the second storage system 15. To synchronize the logical volume (Data1′) and the logical volume (ORG1) 110, first, the pair status between the logical volume (ORG1) 110 and the logical volume (Data1) 150 is set to the suspend state, and an initial copy from the logical volume (ORG1) 110 to the logical volume (Data1′) is performed. Between them, the data update for the logical volume (ORG1) 110 from the host computer 30 is stored as a differential information bitmap. After the initial copy from the logical volume (ORG1) 110 to the logical volume (Data1′) is completed, the data update of the logical volume (Data1′) is performed based on the differential information bitmap. Accordingly, when the logical volume (ORG1) 110 and the logical volume (Data1′) are synchronized, the pair status between them is set to be the pair state. Then, the data update executed on the logical volume (ORG1) 110 is also reflected to the logical volume (Data1′), so that data duplication can be performed.

Further, with regard to determination on whether the third storage system 20 is out of order, a command device 60-1C in the first storage system 10 and a command device 60-2C in the second storage system 15 can be used, for example. The host computer 30 writes to the command device 60-1C a command to allow the first storage system 10 to confirm whether the second storage system 15 is normally operated. When the command is written to the command device 60-1C, the first storage system 10 checks whether the second storage system 15 is normally operated based on intercommunication. In addition, the first storage system 10 writes the command into the command device 60-2C to allow the second storage system 15 to confirm whether the third storage system 20 is normally operated. When the command is written to the command device 60-2C, the second storage system 15 checks whether the third storage system 20 is normally operated based on inter communication.

### Second Embodiment

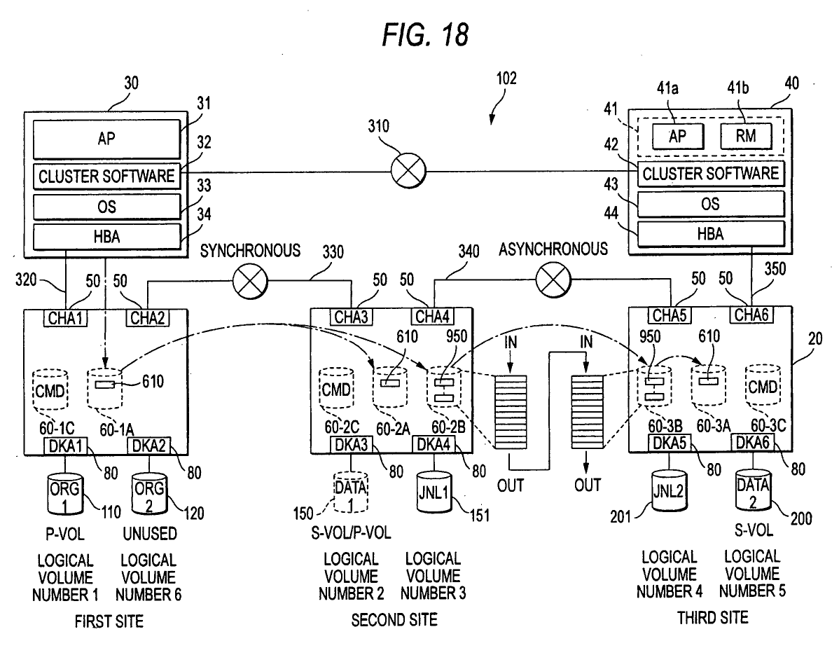

FIG. 18 is a schematic diagram showing a remote copy system 102 according to a second embodiment of the present invention. In FIG. 18, the same components as those in FIG. 1 have the same reference numerals, so that the detailed description thereof will be omitted. According to the present embodiment, a logical volume (Data1) 150 is a physical volume having addresses for designating a storage area, provided by the second storage system 15, from the first storage system 10.

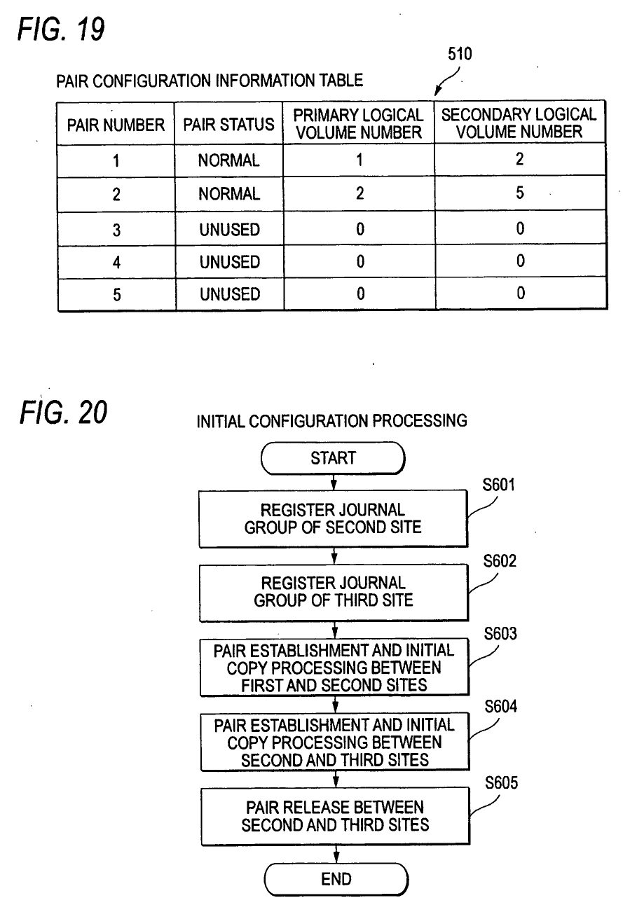

FIG. 19 shows a pair configuration information table 510. In the present embodiment, since the virtual volume is not established, a virtualization ‘ON’ flag is not arranged in the same table.

FIG. 20 is a flow chart for explaining an initial configuration procedure of the remote copy system 102. Each configuration herein can be set such that the user can perform a desired input operation through a graphic user interface (GUI) of service processor or the host computers 30 and 40. The user registers a journal group in each of the second storage system 15 and the third storage system 20 (S601 and S602). More specifically, a pair of the logical volume (Data1) 150 and the logical volume (JNL1) 151 is designated as a journal group 1, and a pair of the logical volume (Data2) 200 and the logical volume (JNL2) 201 is designated as a journal group 2. Next, a pair relation is established between the logical volume (ORG1) 110 and the logical volume (Data1) 150, and an initial copy is performed from the logical volume (ORG1) 110 to the logical volume (Data1) 150 (S603). Accordingly, the logical volume (Data1) 150 retains the same data images as those in the logical volume (ORG1) 110. Next, a pair relation is established between the logical volume (Data1) 150 and the logical volume (Data2) 200, and an initial copy is performed from the logical volume (Data1) 150 to the logical volume (Data2) 200 (S604). Accordingly, the logical volume (Data2) 200 retains the same data images as those in the logical volume (Data1) 150. Next, the pair relation between the logical volume (Data1) 150 and the logical volume (Data2) 200 is released (S605).

When the data images of the logical volume (ORG1) 110 can be copied into the logical volume (Data1) 150 and logical volume (Data2) 200, a copy program in the second storage system 15 or the third storage system 20 reports copy completion to the service processor. After the initialization is ended, recovery can be exactly achieved in the second storage system 15.

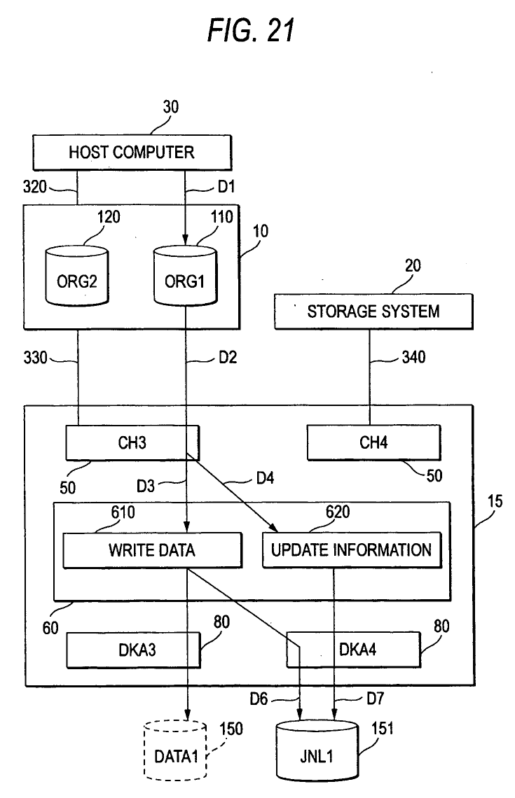

FIG. 21 is a diagram for explaining an access receiving process performed by the second storage system 15. In FIG. 21, the same components as those in FIG. 1 have the same reference numerals, so that the detailed description thereof will be omitted. When the write command is received from the host computer 30, the first storage system 10 writes data into a designated logical volume (ORG1) 110 (process D1). Here, since the logical volume (ORG1) 110 of the first storage system 10 is in a pair relation with the logical volume (Data1) 150 of the second storage system 15, the first storage system 10 issues the same write command as that received from the host computer 30 to the second storage system 15 (process D2). The write command is received by the target channel adaptor (CHA3) 50. The target channel adaptor (CHA3) 50 writes the write data 610 into the storage area of the cache memory 60 corresponding to the write data area 9100 of the logical volume (JNL1) 151 (process D3). In addition, the write command is written into the storage area of the cache memory 60 corresponding to the update information area 9000 of the logical volume (JNL1) 151, as the update information 620 at positions of the logical volume (Data1) 150 (operation D4). The disk adaptor (DKA3) 80 writes the write data 610 of the cache memory 60 into the logical volume (Data1) 150, at the proper timing (process D5). The disk adaptor (DKA4) 80 writes the write data 610 and the update information 620 of the cache memory 60 into the logical volume (JNL1) 151, at the proper timing (processes D6 and D7).

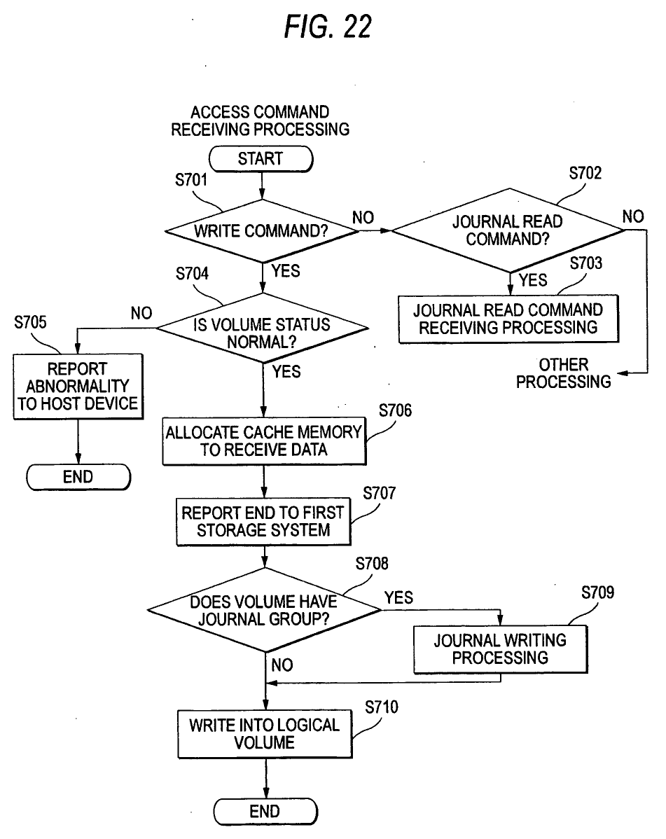

FIG. 22 is a flowchart for explaining an access receiving process performed by the second storage system 15. The access receiving process performed by the second storage system 15 will now be described with reference to FIG. 22. When the access command is received, the target channel adaptor (CHA3) 50 of the second storage system 15 determines whether the access command is a write command (S701). In the case in which the access command is not a write command (S701; NO) but a journal read command (S702; YES), a journal read command receiving process is performed (S703). The details of the journal read command receiving process are described above. On the other hand, in the case in which the access command is a write command (S701; YES), it is determined that the volume for writing is normal (S704). In the case in which the volume status is not normal (S704; NO), abnormality is reported to the service processor or the upper level device (the first storage device 10) (S705), and then, the processing is ended. On the other side, in the case in which the volume status is normal (S704; YES), the target channel adaptor (CHA3) 50 reserves the cache memory 60 to prepare data reception and receives data from the first storage system 10 (S706). When the target channel adaptor (CHA3) 50 receives data, the end of processing is reported to the first storage system 10 (S707). Then, the target channel adaptor (CHA3) 50 determines whether the logical volume (Data1) 150 is a logical volume having the journal group with reference to the journal group configuration information table 600 (S708). When the logical volume (Data1) 150 is a logical volume having the journal group (S708; YES), the writing processing of the journal data 950 is performed on the logical volume and the logical volume (JNL1) 151 constituting the journal group (S709). Next, at any timing, the disk adaptor (DKA3) 80 writes the write data 610 into the logical volume (Data1) 150, and the disk adaptor (DKA4) 80 writes the journal data 950 into the logical volume (JNL1) 151 (S710).

### Third Embodiment

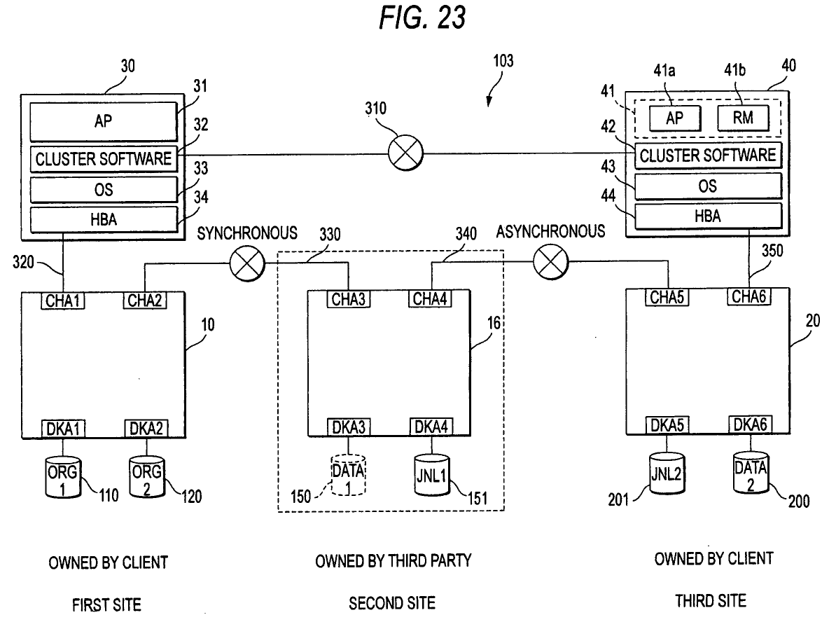

FIG. 23 is a schematic diagram showing a remote copy system 103 according to a third embodiment of the present invention. In FIG. 23, the same components as those in FIG. 1 have the same reference numerals, so that the detailed description thereof will be omitted. In the present embodiment, the operating data processing system (the first storage system 10 or the host computer 30) arranged in the first site and the alternative data processing system (the third storage system 20 or the host computer 40) arranged in the third site are owned by the client, while a second storage system 16 arranged in the second site is owned by a third party. The third party lends the second storage system 16 to the client. The client may be a businessman borrowing the second storage system 16 from the third party, and does not include a general client receiving services from the operating or alternative data processing system. Since each of the storage systems 10, 15, and 20 are very expensive systems, it is too burdensome for a user to possess all of them. Therefore, according to the present embodiment, the remote copy system 103 can be implemented at low costs by borrowing the second storage system 16 from the third party rather than by possessing it. The second storage system 16 serves to reflect the data update on the first storage system 10 by the host computer 30 into the third storage system 20. However, since the third party owns the second storage system 16, the alternative data processing system is not mounted on the second storage system 16. In the case in which the operating data processing system in the first site is out of order, the process fails over to the alternative data processing system in the third site. As described below, in a specific process of the failover, the data images of the third storage system 20 are controlled to be identical with those of the first storage system 10. In addition, although the logical volume (Data) 150 has been described as a virtual volume, it may be a physical volume.

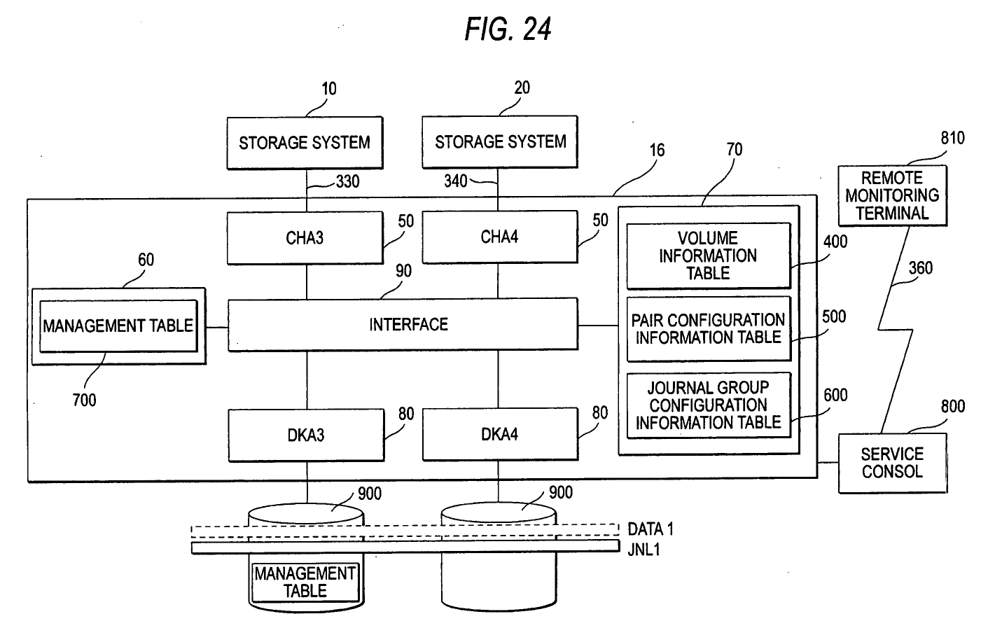

FIG. 24 is a schematic diagram of the second storage system 16. Here, the same components as those in FIG. 3 have the same reference numerals, so that the detailed description thereof will be omitted. A management table 700 for managing the remote copy of the client resides on the cache memory 60 or the physical volume 900. In the management table 700, a client identification code, a permission period (lending period), a permission capacity (secondary logical volume or journal volume capacity), a data type (distinguish whether a secondary logical volume is a physical volume or a virtual volume), a code status (for example, a remote copy incomplete, a remote copy in processing, a remote copy completed), and a data open mode, etc., are registered. The data open mode refers to a mode for determining whether to open data in the second storage system 16 in the case in which data is remote-copied from the second storage system 16 to the third storage system 20. Since the third party owns the second storage system 16, it may be undesirable to the user that the complete copy of the data in the first storage system 10 is retained in the second storage system 16. By setting the data in the second storage system 16 to be remote-copied and opened, the afore-mentioned client request may be fulfilled. In addition, since the second storage system 16 has a small capacity of the storage resource lent to the client, the third party may provide the second storage system to a plurality of clients. Further, in the case in which the data in the second storage system 16 is retained rather than opened after remote-coping, since the second storage system 16 as well as the third storage system 20 may retain the copy of the data in the first storage system 10, it is possible to perform data duplication and to improve liability. Each item in the management table 700 can be set and changed by using a service console 800. In addition, the management table 700 maybe referred to from a remote monitoring terminal 810 through a communication line 360. The third party may charge a bill based on the amount of usage of the second storage system 16 lent to the clients. In the charging method, a fixed period charging or a weighted amount charging may be employed.

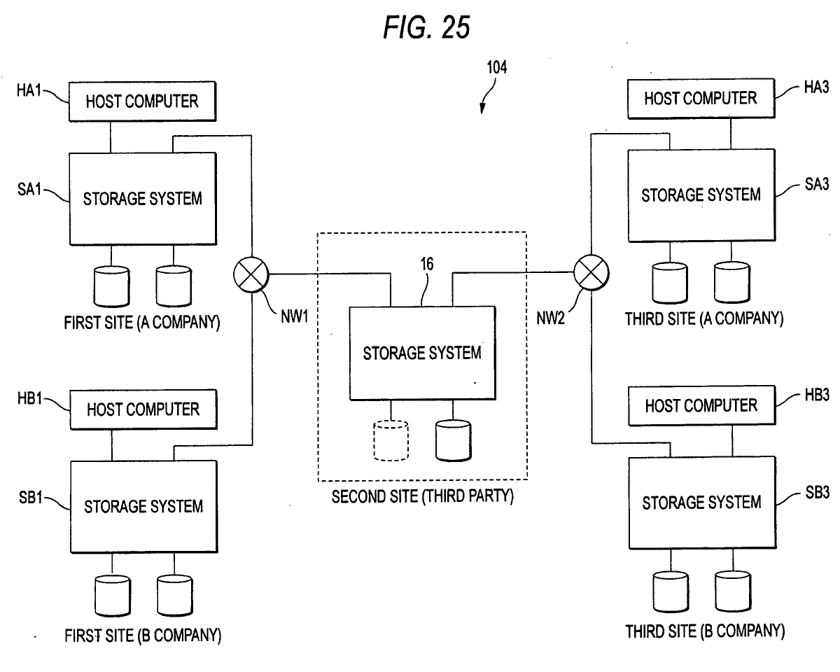

FIG. 25 shows a remote copy system 104 in which a plurality of clients can commonly use the second storage system 16. An operating data processing system comprising a storage system SA1 and a host computer HA1 is constructed in the first site of a company A and is connected to the second storage system 16 through a communication line NW1. An alternating data processing system comprising a storage system SA3 and a host computer HA3 is constructed in the third site of the company A and is connected to the second storage system 16 through a communication line NW2. Likewise, an operating data processing system comprising a storage system SB1 and a host computer HB1 is constructed in the first site of a company B and is connected to the second storage system 16 through the communication line NW1. An alternative data processing system comprising a storage system SB3 and a host computer HB3 is constructed in the third site of the company B and is connected to the second storage system 16 through the communication line NW2. The second storage system 16 arranged in the second site is lent to both the companies A and B. Therefore, both companies can share the second storage system 16. In addition, in the case in which the second storage system 16 is lent to a plurality of clients, the user may logically segment a hardware resource of the second storage system 16 for each client.

Accordingly, in the case in which the second storage system 16 is lent to the clients, the client may operate the data processing system without recognizing the existence of the second storage system 16. From another point of view, it can be appreciated that the clients may borrow the communication lines NW1 and NW2 to connect the operating data processing system and the alternative data processing system. However, even when the operating data processing system and the alternative data processing system are connected to each other through a typical communication line, in the case in which the operating data processing system is out of order, it is not always possible to perform failover to the alternative data processing system. This is because the data images of the operating data processing system at the time of failover and the data images of the alternative data processing system may not be matched with each other in many cases when the remote copy from the operating data processing system to the alternative data processing system is made in the asynchronous transmission. However, according to the present embodiment, the operating data processing system and the alternative data processing system are not connected to the respective single communication lines NW1 and NW2, but are connected to the second storage system 16 through the communication lines NW1 and NW2. Therefore, the data (or differential information) having not yet transmitted from the operating data processing system to the alternative data processing system is stored in the second storage system. Thus, at the time of failover, the data images of the alternative data processing system can be matched to the data images of the operating data processing system. Therefore, according to the present embodiment, the client uses a configuration in which the operating data processing system is connected to the alternative data processing system by borrowing the communication lines NW1 and NW2, while, in some cases, having a merit in that the operating data processing system and the alternative data processing system can be safely failed over. As an operation type of the second storage system 16, a communication service provider (carrier) having a communication infrastructure may lend the second storage system 16 in addition to the communication lines NW1 and NW2 as a service type.

### Fourth Embodiment 4

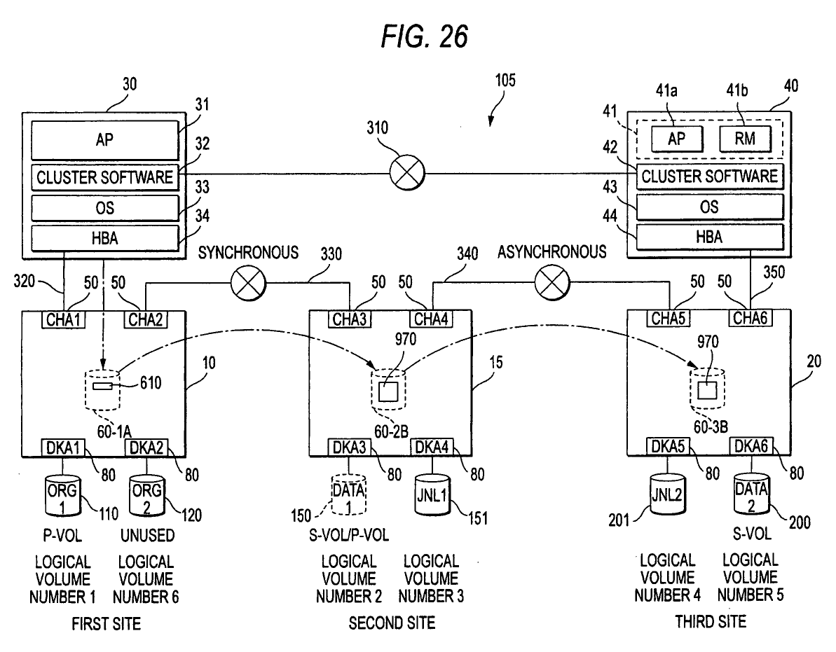

FIG. 26 is a schematic diagram showing a remote copy system 105 according to a fourth embodiment of the present invention. In FIG. 26, the same components as those in FIG. 1 have the same reference numerals, so that the detailed description thereof will be omitted. According to the afore-mentioned embodiments, the data update on the first storage system 10 is reflected into the third storage system 20 by using the journal data 950. However, in the present embodiment, the remote copy for each of the storage systems 10, 15, and 20 is implemented by using an adaptive copy. In the second storage system 15, without guaranteeing the order of the date update to the first storage system 10 during a predetermined time, the differential information thereof is written on a storage area 60-2B of the cache memory 60 as bitmap information 970. The second storage system 15 transmits the bitmap information 970 to the third storage system 20 at an asynchronous timing with the date update to the first storage system 10 by the host computer 30. The bitmap information 970 transmitted to the third storage system 20 is written on a storage area 60-3B of the cache memory 60. The disk adaptor (DKA6) 80 performs data update to the logical volume (Data2) 200, based on the bitmap information 970. However, it is necessary that the bitmap information 970 comprise the differential information between the data update of the first storage system 10 and the data update of the third storage system 20. In addition, based on the bitmap information 970, in performing the data update of the logical volume (Data2) 200, it is necessary that the logical volume (ORG1) 110 as a primary logical volume and the logical volume (Data2) 200 as a secondary logical volume have the same data images at a certain point of time. The transmission of the bitmap information 970 from the second storage system 15 to the third storage system 20 may be performed by a PULL method which transmits the bitmap information in response to a request from the third storage system 20, or alternatively, by a PUSH method which transmits the bitmap information in response to a request from the second storage system 15.

### Fifth Embodiment

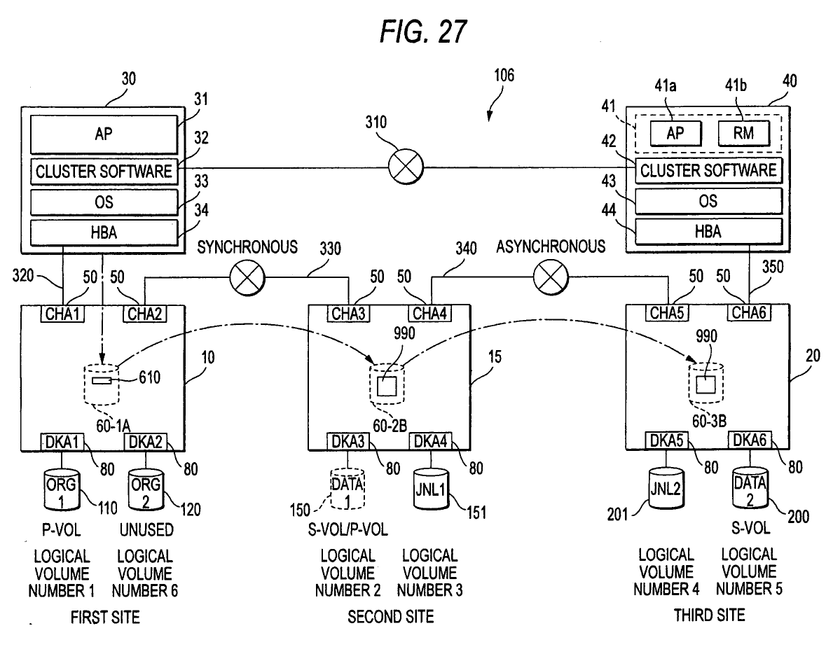

FIG. 27 is a schematic diagram showing a remote copy system 106 according to a fifth embodiment of the present invention. In FIG. 27, the same components as those in FIG. 1 have the same reference numerals, so that the detailed description thereof will be omitted. According to the afore-mentioned fourth embodiment, the remote copy is adaptively performed. However, in the present embodiment, the remote copy is performed using a side file 990. The side file 990 is a transmission data conservation area where sequence numbers are attached in a time series to the address designated by a write command. When there is an update request for data from the host computer 30 to the first storage system 10, the side file 990 is written on the storage area 60-2B of the cache memory 60 in the second storage system 15. The second storage system 15 transmits the side file 990 to the third storage system 20 at an asynchronous timing with the data update to the first storage system 10 by the host computer 30. The side file 990 transmitted to the third storage system 20 is written on the storage area 60-3B of the cache memory 60. The disk adaptor (DKA6) 80 performs data update to the logical volume (Data2) 200 based on the side file 990. The transmission of the side file 990 from the second storage system 15 to the third storage system 20 may performed by a PULL method which transmits the side file in response to a request from the third storage system 20, or alternatively, by a PUSH method which transmits the side file in response to a request from the second storage system 15.

1. A remote copy system comprising:
a first storage system connected to a first upper level computing system to transmit or receive data to or from the first upper level computing system;
a second storage system connected to the first storage system to receive data from the first storage system; and
a third storage system connected to the second storage system to receive data from the second storage system and connected to a second upper level computing system to transmit or receive data to or from the second upper level computing system,
wherein the first storage system has a first storage area on which the data transmitted from the first upper level computing system is written,
wherein the second storage system has a logical address on which the data transmitted from the first storage system is written and a second storage area on which data to be written on the logical address and update information on the data are written,
wherein the third storage system has a third storage area on which the data read from the second storage area and update information on the data are written and a fourth storage area where the first storage area is copied, and
wherein, after a predetermined time, the data written on the second storage area and the update information are read from the third storage system and are then written to the third storage area.

2. The remote copy system according to claim 1,
wherein, at a time of failover from the first upper level computing system to the third upper level computing system, the data not transmitted from the second storage area to the third storage area and the update information are read from the third storage system and are then written on the third storage area.

3. The remote copy system according to claim 1,
wherein a physical storage area is not allocated in the logical address, and
wherein the data and the update information are written to the second storage area.

4. The remote copy system according to claim 3,
wherein, when the first or third storage system is out of order, the second storage system allocates the physical storage area in the logical address, and
wherein the data written on the first or fourth storage area is copied on the physical storage area.

5. The remote copy system according to claim 1,
wherein a physical storage area is allocated in the logical address, and the data is written to the physical storage area, and
wherein the data and the update information are written on the second storage area.

6. The remote copy system according to claim 1,
wherein, after the data and the update information are transmitted from the second storage area to the third storage area, the second storage area is opened.

7. The remote copy system according to claim 1,
wherein, when the amount of the data and the update information not transmitted from the second storage area to the third storage area exceeds a predetermined threshold value, a write access from the first upper level computing system to the first storage system is restricted.

8. The remote copy system according to claim 1,
wherein the storage capacities of the second and third storage areas are set to be smaller than those of the first and fourth storage areas.

9. The remote copy system according to any one of claims 1 to 8,
wherein the second storage system has a function of monitoring data communication traffic transmitted from the first storage system to the third storage system via the second storage system.

10. The remote copy system according to claim 9, comprising a remote monitoring terminal referring to the data communication traffic.

11. The remote copy system according to claim 1,
wherein the second storage system is connected to a plurality of the first storage systems and a plurality of the third storage systems.

12. A storage system comprising:
first and second storage systems, the first storage system transmitting or receiving data to or from a first upper level computing system and including a first storage area on which the data transmitted from the first upper level computing system is written, the second storage system transmitting or receiving data to or from a second upper level computing system and including a second storage area on which the first storage area is copied, and;
a third storage area having a logical address on which the data transmitted from the first storage system is written, the third storage area being written with data to be written to the logical address and update information on the data,
wherein the data and the update information written on the third storage area are transmitted to the second storage system after a predetermined time.

13. The storage system according to claim 12,
wherein, at a time of failover from the first upper level computing system to the second upper level computing system, the data and the update information not transmitted from the third storage area to the second storage system are transmitted to the second storage system.

14. The storage system according to claim 12,
wherein a physical storage area is not allocated in the logical address, and
wherein the data and the update information are written on the third storage area.

15. The storage system according to claim 13,
wherein, when the first or second storage system is out of order, the storage system allocates the physical storage area in the logical address, and the data written on the first or second storage area is copied on the physical storage area.

16. The storage system according to claim 12,
wherein a physical storage area is allocated in the logical address, and the data is written on the physical storage area, and
wherein the data and the update information are written on the third storage area.

17. The storage system according to claim 12,
wherein, after the data and the update information are transmitted from the third storage area to the second storage system, the third storage area is opened.

18. The storage system according to claim 12,
wherein the storage capacity of the third storage area is set to be smaller than those of the first and second storage areas.

19. The storage system according to claim 12,
wherein the storage system has a function of monitoring data communication traffic transmitted from the first storage system to the second storage system via the second storage system.

20. The storage system according to claim 19, comprising a remote monitoring terminal referring to the data communication traffic.

21. The storage system according to claim 12,
wherein the storage system is connected to a plurality of the first storage systems and a plurality of the second storage systems.

22. A remote copy system comprising:
a first storage system connected to a first upper level computing system to transmit or receive data to or from the first upper level computing system;
a second storage system connected to the first storage system to receive data from the first storage system; and
a third storage system connected to the second storage system to receive data from the second storage system and connected to a second upper level computing system to transmit or receive data to or from the second upper level computing system,
wherein the first storage system has a first storage area on which the data transmitted from the first upper level computing system is written,
wherein the second storage system has a second storage area on which differential information representing an update position of the data written on the first storage area is written,
wherein the third storage system has a third storage area on which the differential information read from the second storage area is written and a fourth storage area on which the first storage area is copied, and
wherein, after a predetermined time, the differential information written on the second storage area is read from the third storage system and is then written on the third storage area.

23. The remote copy system according to claim 22,
wherein, at a time of failover from the first upper level computing system to the second upper level computing system, the differential information not transmitted from the second storage area to the third storage area is read from the third storage system and is then written on the third storage area.
